(19) United States
(12) Patent Application Publication
(10) Pub. No.: US 2019/0315384 A1
(43) Pub. Date: Oct. 17, 2019

(54) BUCKET AND TOOL TRANSPORTER

(71) Applicant: Kratos Tool Systems LLC, Staten Island, NY (US)

(72) Inventor: Richard Sirico, Allentown, PA (US)

(21) Appl. No.: 16/268,594

(22) Filed: Feb. 6, 2019

Related U.S. Application Data
(60) Provisional application No. 62/658,262, filed on Apr. 16, 2018.

(51) Int. Cl. B62B 3/10; F16M 11/42; B25H 3/00; B62B 3/12

(52) U.S. Cl. CPC B62B 3/104; F16M 11/42; B62B 2301/044; B62B 3/12; B62B 2202/028; B25H 3/00

(57) ABSTRACT

A transporting device includes four arms arranged substantially parallel with one another and defining a cavity for receiving a bucket having a diameter, the four arms being spaced apart from one another so that a cross-section of the four arms includes the four arms positioned on vertices of an imaginary square having four sides and two diagonals, each of the four sides having a length that is less than the diameter of the bucket, and each of the two diagonals having a length that is greater than the diameter of the bucket, a base coupled to one end of each of the four arms, and at least one wheel coupled to the base.

### CROSS-REFERENCE TO RELATED APPLICATIONS

This application claims priority to U.S. Provisional Application Ser. No. 62/658,262, filed Apr. 16, 2018, entitled “BUCKET AND TOOL TRANSPORTER,” the contents of which are hereby incorporated by reference in their entirety as if fully set forth herein.

### FIELD OF THE DISCLOSURE

The present disclosure relates to construction and home improvement equipment. More particularly the present disclosure relates to a device and method for storing and transporting buckets and tools while working on such projects and similar ones.

### BACKGROUND OF THE DISCLOSURE

It is common for tradesmen to transport heavy equipment while working. Such workers include framers, tapers, painters and others. One common piece of equipment that is used during construction and home renovations are large buckets. These can transport material such as paint, primer, joint compound, hand tools, power tools, nails, and a number of others items. Such buckets tend to be large, and when filled with material, are extremely heavy.

During certain tasks, two individuals are required to work together—a first person will perform the type of work needed (e.g., applying joint compound), and a second person will follow the first individual and hand him the necessary tools and materials. If only one person is doing the task, the work is regularly interrupted to move and retrieve equipment and materials. Thus, jobs take longer than necessary, require more workers than required and cost more.

### SUMMARY OF THE DISCLOSURE

In some embodiments, a transporting device includes at least three arms arranged substantially parallel with one another, the at least three arms being spaced apart from one another to form a cavity for housing a five-gallon bucket having a diameter, the bucket being incapable of passing between any two of the at least three arms, a base coupled to one end of each of the at least three arms, and at least one wheel coupled to the base.

A transporting device includes four arms arranged substantially parallel with one another and defining a cavity for receiving a bucket having a diameter, the four arms being spaced apart from one another so that a cross-section of the four arms includes the four arms positioned on vertices of an imaginary square having four sides and two diagonals, each of the four sides having a length that is less than the diameter of the bucket, and each of the two diagonals having a length that is greater than the diameter of the bucket, a base coupled to one end of each of the four arms, and at least one wheel coupled to the base.

A system of tools including includes a bucket having a diameter, and a transportation device including four arms arranged substantially parallel with one another and defining a cavity for receiving the bucket, the four arms being spaced apart from one another so that a cross-section of the four arms includes the four arms positioned on vertices of an imaginary square having four sides and two diagonals, each of the four sides having a length that is less than the diameter of the bucket, and each of the two diagonals having a length that is greater than the diameter of the bucket, a base coupled to one end of each of the four arms, and at least one wheel coupled to the base.

### BRIEF DESCRIPTION OF THE DISCLOSURE

Various embodiments of the presently disclosed connectors are disclosed herein with reference to the drawings, wherein:

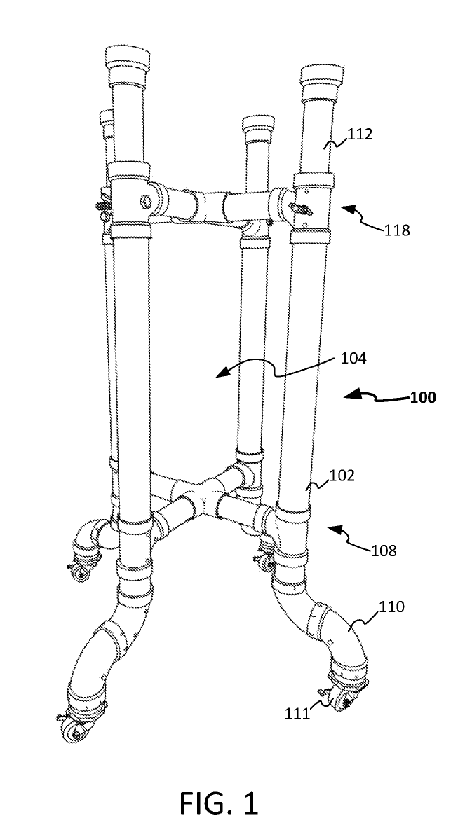

FIG. 1 is a schematic perspective view of a transporting apparatus according to one embodiment of the present disclosure;

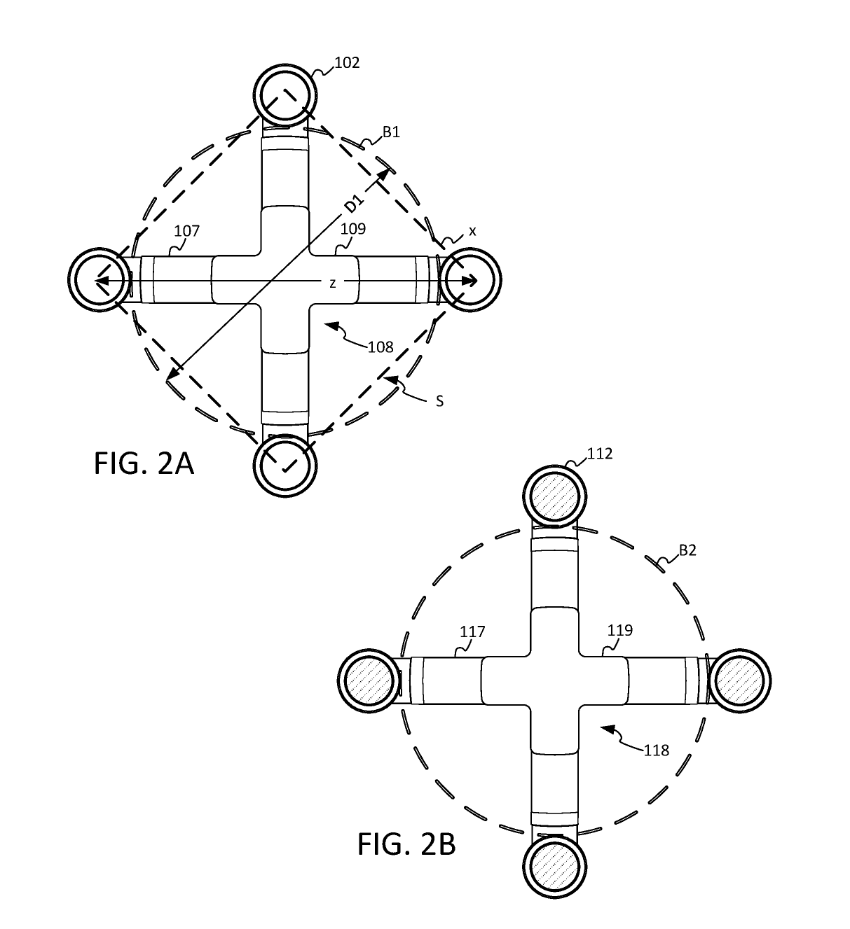

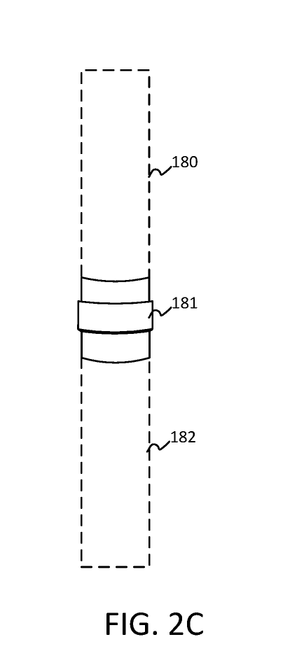

FIGS. 2A and 2B are schematic top views of the lower and upper support of the transporting apparatus of FIG. 1;

FIG. 2C illustrates one example of an extendable arm according to one embodiment of the present disclosure;

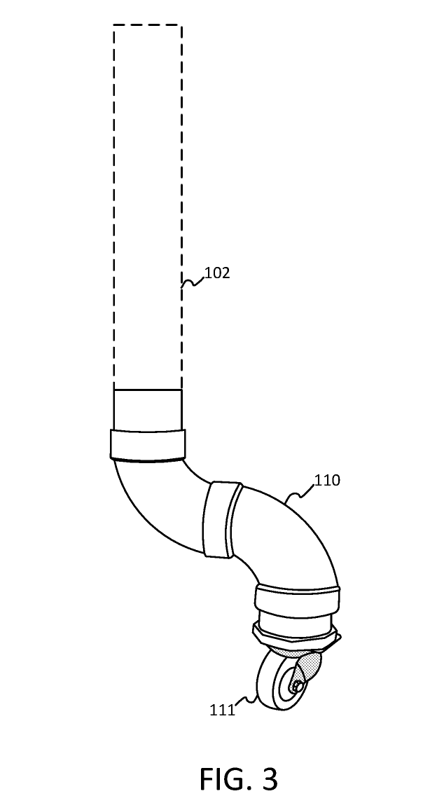

FIG. 3 is a schematic illustration of one example of a leg having a wheel; and

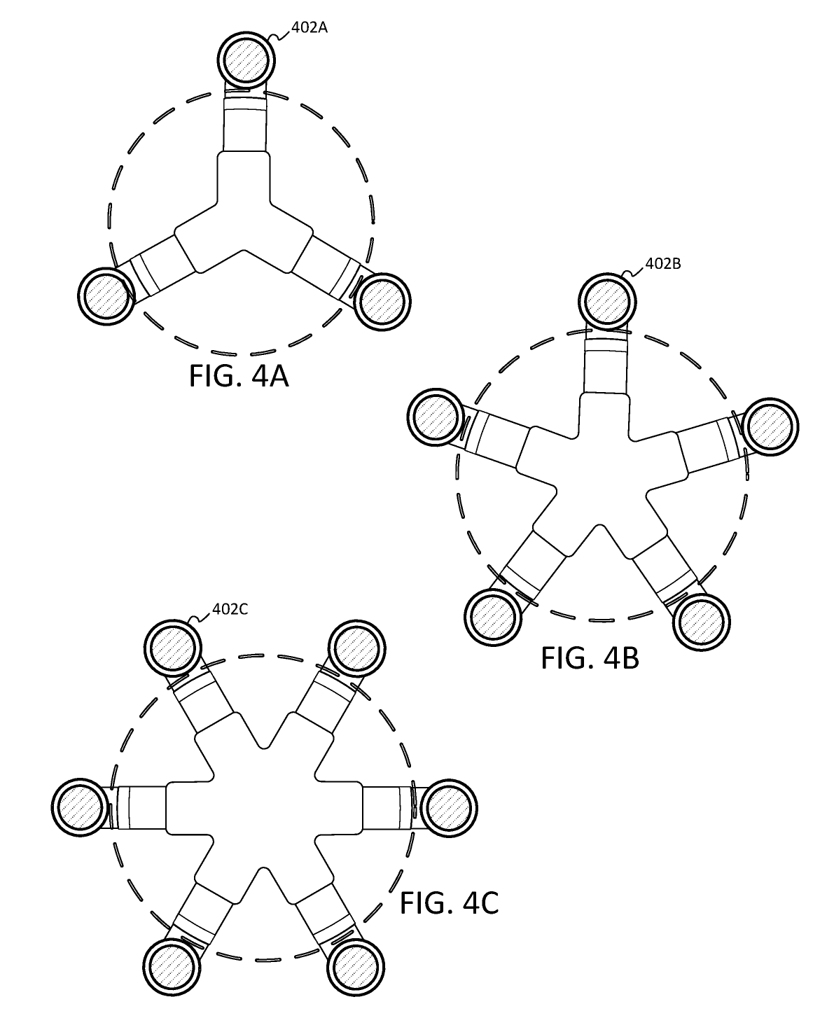

FIGS. 4A-C illustrate schematic illustrations of some other arrangements of the arms of the present disclosure.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to construction and home improvement equipment, conventional methods suffer from some shortcomings as discussed above.

There therefore is a need for further improvements to the devices and methods used to transport large items during construction, repair and renovation, such as those improvements outlined below. Although many of the examples described herein are detailed in connection with painting or applying joint compound, it will be understood that the principles of the disclosure are equally applicable to other trades and tasks such as demolition, framing, drywall installation, joint compound application, priming, painting, electricians, plumbing and others. Among other advantages, the present disclosure may address one or more of these needs.

FIG. 1 illustrates a transporting device 100. Transporting device includes a first set of at least three arms 102 arranged substantially parallel with one another. In the embodiment shown, transporting device 100 includes four arms 102 formed as pipes having a diameter of 1-4 inches, and specifically approximately 2-3 inches. Each of the four arms may be formed of a metal, a wood, a plastic or other polymeric material, or combinations of materials. In at least some examples, the four arms are formed of hollow polyvinyl chloride (PVC) pipes. The arms may be arranged to form a cavity 104 therebetween, the cavity being capable of accepting a bucket therein. In at least some examples, the position of the arms 102 are selected so as to entrap a five-gallon bucket “B1”. Standard five-gallon buckets typically have a diameter “D1” of about 12 inches and a height of 13 inches. By entrapment of the bucket, it is meant that the bucket may be inserted into the cavity formed by the arms from above, but that it is incapable of passing radially outward from between any two arms. Thus, the bucket is secured when entrapped and can only be removed from the cavity by lifting it up and out over the arms. In at least some examples, this entrapment can be achieved by arranging the four arms along vertices of an imaginary square “S”, the square having four sides “x” (i.e., the distances between the centers of adjacent arms) and two diagonals “z” (i.e, the distance between the centers of two diagonally-opposing arms). The length of the sides “x” of the imaginary square may be between 10 and 13 inches. In some examples, the length of the sides “x” is preferably smaller than the diameter “D1” of the standard five-gallon bucket, or sized so that the distance between the two adjacent arms (as opposed to the centers of the arms) is smaller than the diameter “D1”. The length of the diagonals “z” may be between 14 and 17.5 inches, and preferably slightly larger than the diameter of the standard five-gallon bucket. That is, the device may be formed such that arms are disposed along the imaginary square having sides “x” and diagonals “z” and configure to house a bucket with diameter “D1,” such that x>D1>z. Of course, it will be understood that differently-sized buckets may be housed within transporting devices having other sizes so long as the relationships described above are maintained.

A second set of arms 112 may be positioned in a concentric arrangement with the first set of arms 102, and may have a diameter that is slightly greater or smaller than the first set of arms so that the two sets of arms can mate with one another and translate relative to one another, one inside the other, to form an extendable system. Thus, arms 102 and 112 may be extendable so that they have a minimum length of approximately 23.5 inches, and a maximum length of approximately 52 inches. In one embodiment, second set of arms 112 may include a set of spring-loaded pins on each arm 112, and each of the first set of arms 102 may include a number of holes disposed at various locations along the length of the arm 102, the holes being capable of receiving one of the pins so that the total length of the first and second sets of arms may be modified. Alternatively, one or more of the arms may be formed of separable portions 180, 182 that are coupled together via a connector 181, the connector having a slightly larger diameter than the separable portions and capable of receiving two ends of the separable portions 180,182 therein and secure them through frictional engagement. This embodiment includes less moving parts (e.g., no spring-loaded pins), and the user may choose to add or remove separable portions 180,182 as desired to achieve a desired height of the arms. Additionally, as shown in FIG. 1, arms 102 and 112 may be separable so that a user may slide a bucket “B1” from above the arms into the cavity created by arms 102.

Arms 102 may be coupled to a base 106 on one end. Similar to arms 102, base 106 may be formed of a number of PVC pipes as well, and may define a lower support 108. In one example, shown in FIG. 2A, lower support 108 includes two cross-braces 109 extending between diagonally-opposing pairs of arms, the two cross-braces being attached to one another at their centers via socket 107 to form an X-shaped lower support 108. The lower support may be rigid so that bucket “B1” securely lays thereupon. It will be understood that cross-braces 109 may also be unitarily formed.

Attached to second set of arms 112 is an upper support 118 that is arranged in a manner similar to lower support 108 (FIG. 2B). Specifically, upper support 118 may include two cross-braces 119 extending between diagonally-opposing pairs of arms, the two cross-braces being attached to one another at their centers via socket 117 to form an X-shaped upper support 118. The upper support may be rigid so that a second bucket “B2” or other tool may securely lay thereupon, the second bucket “B2” being entrapped by upper arms 112 in the same manner described above with respect to bucket “B1” and arms 102. Upper support 118 may be fastened to upper arms 112 so that removal of the upper arms 112 also removes the upper support to load or unload bucket “B1”. Additionally, upper support 118 may be placed at a location along second set of arms 112 so that a portion of the arms 112 extends above the upper supports 118 and defines a cavity for receiving and entrapping the second bucket.

Connected to cross-braces 109 are legs 110, each of the legs extending radially outward of the base. Each leg may be connected to a wheel 111, the radial extension of the legs forming a wide base to prevent tipping over of the apparatus (FIG. 3). That is, each leg 110 may flare outwardly so that the wheel to which they are connected are spaced from one another a larger distance than the spacing between the arms 102. In some examples, each leg is S-shaped as shown in FIG. 3. Alternatively, the legs may simply be slanted with respect to the arms 102 to provide a larger wheel base. In some examples, four legs 110 and four wheels are coupled to base 106. It will be understood, however, that the number of legs and wheels may be modified, and that three leg-wheel, five leg-wheel or six leg-wheel combinations are possible.

Upper support may be spaced from lower support by a distance of about 23.5 inches to about 38.5 inches. In at least some example, the distance between upper and lower supports is slightly larger than the height of a standard five-gallon bucket (i.e., slightly larger than 13 inches). Additionally, the height of the upper support from the floor may be chosen so that a worker who is standing on stilts may reach into the bucket without climbing down from the stilts. For example, it is common for workers to stand on three-foot stilts to work on the upper portions of walls or ceilings. By having an upper support that is elevated to a distance of between 3 feet and 8 feet from the floor, the user may reach down and obtain more material from bucket “B2.” Additionally, because transporting device 100 is disposed on wheels, the worker may move on to the next section of wall or ceiling and simply push the device 100 with all of its buckets, tools, etc. without having to climb down from the stilts.

It will be understood that the instant device may also be formed of sets of three arms 402A (FIG. 4A), or sets of five arms 402B (FIG. 4B) or six arms 402C (FIG. 4C) or more arms, such as shown in FIGS. 4A-C. For example, as seen from above, the arms may form an equilateral triangle, a pentagon or a hexagon.

To use the transporting device, the user may begin with the upper set of arms 112 and upper support 118 removed, and may lower a first bucket between the first of arms 102 so that the bucket having material is entrapped between the arms. The second set of arms 112 may then be coupled to the first set of arms 102 and secured thereto. The user may then lower a second bucket into the second cavity defined by the second set of arms 112. Thus, the transporting device is now loaded with two buckets of material. While working the user may work with or without stilts, and may reach down into the top bucket to obtain material (e.g., paint, primer, joint compound, etc.) or tools necessary to complete his task. When the user desires to move to a different location, he may walk on his stilts, for example, and roll the transporting device and the buckets to the next location. This can be done without removing the stilts, if they are being used. The user may then resume his work at the second location. Once the top bucket is empty, or a second material is needed from a different bucket, the two buckets may be switched on the supports so that more material is available for the user.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. For example, instead of X-shaped cross-braces, a square or circular platform may be used to form lower and upper supports. Additionally, upper and lower supports may be the same or different in configuration.

It will be appreciated that the various dependent claims and the features set forth therein can be combined in different ways than presented in the initial claims. It will also be appreciated that the features described in connection with individual embodiments may be shared with others of the described embodiments.

What is claimed is:

1. A transporting device comprising:
at least three arms arranged substantially parallel with one another, the at least three arms being spaced apart from one another to form a cavity for housing a bucket having a diameter of 12 inches, the bucket being incapable of passing between any two of the at least three arms;
a base coupled to one end of each of the at least three arms; and
at least one wheel coupled to the base.

2. The transporting device of claim 1, wherein the at least three arms includes three arms and a cross-section of the three arms includes the three arms positioned on vertices of an imaginary equilateral triangle.

3. The transporting device of claim 1, wherein the base includes a platform on an opposite side of the at least on wheel.

4. The transporting device of claim 1, wherein the at least one wheel includes four wheels coupled to the base.

5. The transporting device of claim 1, wherein the at least three arms includes four arms and so that a cross-section of the four arms includes the four arms positioned on vertices of an imaginary square.

6. The transporting device of claim 5, wherein each of the four arms are spaced from an adjacent arm by a distance of between 9 and 11 inches.

7. The transporting device of claim 5, wherein the cavity is sized to receive a bucket having a height of 13.

8. The transporting device of claim 5, wherein the cavity is sized to receive a five-gallon bucket.

9. The transporting device of claim 7, wherein the four arms are spaced apart so that the imaginary square has four sides and two diagonals, each of the four sides having a length that is less than the diameter of the bucket, and each of the two diagonals having a length that is greater than the diameter of the bucket.

10. The transporting device of claim 2, wherein the imaginary equilateral triangle has three sides, each sides having a length that is less than a diameter of the bucket.

11. A transporting device comprising:
four arms arranged substantially parallel with one another and defining a cavity for receiving a bucket having a diameter of 12 inches, the four arms being spaced apart from one another so that a cross-section of the four arms includes the four arms positioned on vertices of an imaginary square having four sides and two diagonals, each of the four sides having a length that is less than the diameter of the bucket, and each of the two diagonals having a length that is greater than the diameter of the bucket;
a base coupled to one end of each of the four arms; and
at least one wheel coupled to the base.

12. The transporting device of claim 11, wherein the base includes four legs, and the at least one wheel includes four wheels, each of the legs being coupled to one of the four wheels.

13. The transporting device of claim 12, wherein the four legs extend radially outward from the base.

14. The transporting device of claim 11, wherein each of the four arms are spaced from an adjacent arm by a distance of between 9 and 11 inches.

15. The transporting device of claim 11, wherein the base forms a lower support having two lower cross-braces that extend along the diagonals of the imaginary square.

16. The transporting device of claim 15, further comprising an upper support having two upper cross-braces that extend along the diagonals of the imaginary square.

17. The transporting device of claim 16, wherein the upper support and the lower support are spaced apart by a distance of at least 23 inches.

18. The transporting device of claim 16, wherein the four arms are extendable.

19. The transporting device of claim 16, wherein the four arms are extendable between a minimum length of 23.5 inches and a maximum length of 52 inches.

20. A system of tools including comprising:
a bucket having a diameter of 12 inches; and
a transportation device, the device comprising:
four arms arranged substantially parallel with one another and defining a cavity for receiving the bucket, the four arms being spaced apart from one another so that a cross-section of the four arms includes the four arms positioned on vertices of an imaginary square having four sides and two diagonals, each of the four sides having a length that is less than the diameter of the bucket, and each of the two diagonals having a length that is greater than the diameter of the bucket;
a base coupled to one end of each of the four arms; and
at least one wheel coupled to the base.
